(19) United States
(12) Patent Application Publication
(10) Pub. No.: US 2011/0234692 A1
(43) Pub. Date: Sep. 29, 2011

(54) MAINTENANCE LIQUID FOR INK JET RECORDING, METHOD OF MANUFACTURING MAINTENANCE LIQUID FOR INK JET RECORDING, INK SET FOR INK JET RECORDING, AND IMAGE FORMING METHOD

(75) Inventors: Akimitsu HAIJIMA, Kanagawa (JP); Mika IMAMURA, Kanagawa (JP)

(73) Assignee: FUJIFILM CORPORATION, Tokyo (JP)

(21) Appl. No.: 13/072,800

(22) Filed: Mar. 28, 2011

(30) Foreign Application Priority Data
Mar. 29, 2010 (JP) 2010-076012

(51) Int. Cl. B41J 2/165; C09D 11/02; C09D 11/10

(52) U.S. Cl. 347/28; 106/311; 106/31.13; 524/366

(57) ABSTRACT

The present invention provides a maintenance liquid for ink jetting, the maintenance liquid including: water and an organic solvent having an ether bond, a content of the organic solvent being from 15% by mass to 40% by mass with respect to maintenance liquid, and a concentration of peroxide in the maintenance liquid being 0.1 mmol/L or lower; a method of manufacturing the above maintenance liquid for ink jetting, the method including a process for mixing water and the organic solvent having an ether bond; and a process for purifying by distilling in advance the organic solvent having an ether bond that is used in the mixing; an ink set for ink jetting including: the maintenance liquid for ink jetting and an aqueous ink composition having a pH of from 7.0 to 10.0; and an image forming method that uses the ink set for ink jetting.

### CROSS-REFERENCE TO RELATED APPLICATION

This application claims priority under 35 USC 119 from Japanese Patent Application No. 2010-076012 filed on Mar. 29, 2010, the disclosure of which is incorporated by reference herein.

### BACKGROUND OF THE INVENTION

1. Field of the Invention

The present invention relates to a maintenance liquid for ink jet recording, a method for manufacturing the maintenance liquid for ink jet recording, an ink set for ink jet recording, and an image forming method.

2. Description of the Related Art

An ink jet recording method refers to a method for performing recording by discharging liquid droplet-like ink from a large number of nozzles arranged in an ink jet head, to a recording medium, and fixing the ink onto the recording medium.

In usual, the ink use in the ink jet recording method generally contains water as the main ingredients and further contains coloring ingredients and an organic solvent for the purpose of preventing clogging or the like. However, in order to obtain a high quality image with high resolution, inks having various compositions have been proposed.

Moreover, a large number of maintenance liquids (also referred to as a washing liquid or a cleaning liquid) for use in wiping or washing a nozzle head portion and the like to which ink has adhered have been developed.

In this regard, a maintenance liquid for ink jet recording, containing water and from 0.3% by mass to 15% by mass of alkylene glycol monoalkyl ether, is disclosed, and it is said that this maintenance liquid is excellent in washing ability (for example, Japanese Patent Application Laid-Open (JP-A) No. 2005-7703).

In addition, an ink-jet-head-washing-liquid containing a solvent having a surface tension lower than 35 mN/m and a basic compound is disclosed, and it is said that stable ejectionability can be maintained over a long period of time (for example, JP-A No. 2009-233911).

However, the maintenance liquid described in the above references reveals a phenomenon in which reduction in pH occurs during storage. The reduction in pH results a reduction in washing ability of the maintenance liquid. Furthermore, in a case in which a maintenance liquid and an ink containing pigments and polymer particles are used in combination, when a discharge head is washed with the maintenance liquid having a reduced pH, the aggregation of the ink is caused because the ink easily aggregates due to the reduction in pH. As a result, washing ability is conspicuously deteriorated.

Examples of the factors that decrease the pH include carbonic acid generated by absorption of carbon dioxide in the air, and decomposition of contents caused by dissolved oxygen. In particular, for the maintenance liquid containing glycol ester or alkylene glycol alkyl ether, these ingredients are easy to be decomposed by dissolved oxygen and the pH is likely to decrease.

The present invention has been made in view of the above description and aims to address the above problems.

More specifically, it is an object of the invention to provide a maintenance liquid for ink jet recording in which a changes in pH over time is suppressed and excellent maintenance properties are secured over a long period of time, and a method for manufacturing the same. It is another object of the invention to provide an ink set for ink jet recording that maintains stable discharge performance over a long period of time and an image forming method capable of forming a high quality image.

### SUMMARY OF THE INVENTION

According to a first aspect of the invention, there is provided a maintenance liquid for ink jet recording, the maintenance liquid including: water and an organic solvent having an ether bond, a content of the organic solvent being in the range of from 15% by mass to 40% by mass with respect to a total mass of the maintenance liquid, and a concentration of peroxide in the maintenance liquid being 0.1 mmol/L or lower.

### DETAILED DESCRIPTION OF THE INVENTION

The term “maintenance” used in the invention means to keep and maintain an ink jet head for discharging an aqueous ink composition and discharge properties thereof at a desired state or a state close to the desired state (keeping up) and in addition to wash (clean) the ink jet head thereby improving the state of the ink jet head into a more favorable state and maintaining the state.

Maintenance Liquid for Ink Jet Recording

The maintenance liquid for ink jet recording of the invention (hereinafter also referred to as “the maintenance liquid”) contains water and at least one organic solvent having an ether bond and may contain other ingredients as required. In the maintenance liquid of the invention, the content of the organic solvent having an ether bond is from 15% by mass to 40% by mass based on a total mass of the maintenance liquid and the concentration of peroxide in the maintenance liquid is 0.1 mmol/L or lower.

Due to the structure, in the maintenance liquid of the invention, a change in pH over time is suppressed and excellent maintenance properties are achieved over a long period of time.

In the maintenance liquid of the invention, the concentration of peroxide is 0.1 mmol/L or lower. When the concentration of peroxide exceeds 0.1 mmol/L, the pH of the maintenance liquid is easy to decrease over time and it is difficult to maintain excellent maintenance properties over a long period of time.

The concentration of peroxide is preferably 0.05 mmol/L or lower and particularly preferably 0 mmol/L.

The pH (25° C.) of the maintenance liquid of the invention is preferably from 6.0 to 8.5. The pH is more preferably from 6.5 to 8.0 and still more preferably from 7.0 to 7.8.

When the pH is 8.5 or lower, a metal or a water-repellent film of an ink jet head is less affected by impairment or the like.

When the pH is 6.0 or more, a washing power increases. In a case in which a pigment ink that aggregates when it is brought into contact with an aggregation liquid described later is used, the aggregation of the ink is not promoted and the washing ability is favorable.

Water

The maintenance liquid of the invention contains water. A water amount is not particularly limited. A preferable content of water is from 50% by mass to 99% by mass based on a total amount of the maintenance liquid.

Organic Solvent

The maintenance liquid of the invention contains an organic solvent having an ether bond. The organic solvent having an ether bond can be selected as appropriate from known substances that are used in a maintenance liquid or aqueous ink.

A content of the organic solvent in the maintenance liquid is from 15% by mass to 40% by mass based on a total mass of the maintenance liquid. When the content of the organic solvent is 15% by mass or more, the maintenance liquid has a striking effect of suppression of a change of pH due to adjustment to 0.1 mmol/L or less of peroxide in the maintenance liquid. When the content of the organic solvent is 15% by mass or more, the maintenance properties are favorable. When the content of the organic solvent is 40% by mass or less, the maintenance properties can be maintained at a high level over a long period of time. The content is more preferably from 18% by mass to 35% by mass and still more preferably from 20% by mass to 30% by mass.

The organic solvent is preferably a water-soluble organic solvent. The water-soluble organic solvent in the invention refers to an organic solvent having solubility of 1% by mass or more with respect to water at 25° C.

Examples of the water-soluble organic solvent having an ether bond include alkyl ethers, such as diethylether, ethylmethylether, or tetrahydrofuran; glycol ethers, such as diethylene glycol monoethyl ether, diethylene glycol monobutyl ether, triethylene glycol monoethyl ether, triethylene glycol monobutyl ether, propylene glycol monobutyl ether, dipropylene glycol monobutyl ether, dipropyrene glycol-t-butyl ether, diethylene glycol monohexyl ether, ethylene glycol mono-2-ethylhexyl ether, or diethylene glycol mono-2-ethylhexyl ether; and glycerin ethers, such as an ethylene oxide or propylene oxide adduct of glycerin.

These water-soluble organic solvents may be used singly or in combination of two or more kinds thereof.

The organic solvent having an ether bond used in the maintenance liquid of the invention is preferably a water-soluble organic solvent represented by Formula (I) below from the viewpoint of the washability of ink.

R¹—(OR²)ₓ—OR³ Formula (1)

In Formula 1, R² represents an ethylene group or a propylene group, each of R¹ and R³ independently represents a hydrogen atom or an alkyl group having 1 to 4 carbon atoms, and x represents an integer from 1 to 4.

Specific examples of the alkyl group having 1 to 4 carbon atoms include a methyl group, an ethyl group, an n-propyl group, an iso-propyl group, an n-butyl group, a sec-butyl group, and a tert-butyl group.

The organic solvent having an ether bond used in the maintenance liquid of the invention is preferably polyalkyleneoxy alkylether. In the maintenance liquid of the invention, when 50% by mass or more of a total mass of the organic solvents to be used is polyalkyleneoxy alkylether, solubility or swelling properties of the maintenance liquid with respect to a solid ink matter attached onto an ink jet head (hereinafter sometimes referred to as “a solid ink matter”) are improved and washability is improved. From the viewpoint of improving solubility of the solid ink matter, the content of the polyalkyleneoxy alkylether based on a total organic solvent content is preferably 60% by mass or more and more preferably 70% by mass or more. The upper limit is not particularly limited.

The polyalkyleneoxy alkylether preferably has from 1 to 4 carbon atoms at the alkylene portion and from 1 to 4 carbon atoms at the alkyl portion.

Specific examples of the polyalkyleneoxy alkylether include ethylene glycol monomethyl ether, ethylene glycol monoethyl ether, ethylene glycol monobutyl ether, dithylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, and triethylene glycol monoethyl ether.

A SP value of the organic solvent having an ether bond used in the maintenance liquid of the invention is preferably 27.5 or less. When the maintenance liquid of the invention contains the ether bond-containing organic solvent having an SP value of 27.5 or less in a proportion of 50% by mass or more based on a total organic solvent, the solubility or the swelling property of the solid ink matter are improved and resultantly the washability is improved.

From the viewpoint of washability, the content of the organic solvent having an SP value of 27.5 or less based on a total organic solvent is more preferably 60% by mass or more, still more preferably 70% by mass or more, and still more preferably 80% by mass or more. From the viewpoint of the washability, the SP value is more preferably 24 or less and still more preferably 22 or less.

The SP value (solubility parameter) of the organic solvent as used in the invention is a value represented by the square root of the molecular cohesive energy and can be calculated by the method described in R. F. Fedors, Polymer Engineering Science, 14, pp. 147 to 154 (1974). This numerical value is used as the SP value in the invention.

Preferable specific examples of the organic solvent represented by Formula (I) described above are shown below. However, the invention is not limited thereto. The numerical value in the brackets is the SP value. The following compounds may be used singly or in combination of two or more kinds thereof.

Diethylene glycol monoethyl ether (DEGmEE) (22.4)

Diethylene glycol monobutyl ether (DEGmBE) (21.5)

Triethylene glycol monobutyl ether (TEGmBE) (21.1)

Dipropylene glycol monomethyl ether (DPGmME) (21.3)

Dipropyrene glycol (DPG) (27.2)

nC₄H₉(OR²)₄—OH(R²=Ethylene group or Propylene group; Ratio of Ethylene group: Propylene group=1:1) (20.1)

H(OP)₃—OH (P represents a propylene group.) (24.7)

Among the above-described compounds, diethylene glycol monobutyl ether is most preferable from the viewpoint of washability of an ink and the water solubility.

The organic solvent having an ether bond for use in the maintenance liquid of the invention is preferably a water-soluble organic solvent having an SP value of 27.5 or less, that is represented by the above-described Formula (1), from the viewpoint that excellent maintenance properties can be maintained at a high level over a long period of time. Specific examples of the water-soluble organic solvent include DEGmEE, DEGmBE, TEGmBE, DPGmME, and DPG. These substances can be used singly or as a mixture of two or more kinds thereof.

Basic Compound

The maintenance liquid of the invention is preferably at least one basic compound. When the at least one basic compound is contained therein, a pH buffering ability may be imparted to the maintenance liquid.

The basic compound used in the maintenance liquid of the invention is not particularly limited, so long as it has a pH buffering ability in the pH rang of from 6.0 to 8.5, that is a preferable pH (25° C.) rang of the maintenance liquid. The basic compound preferably has solubility of 5 m mol/L or more with respect to a mixed solvent of water and an organic solvent that are solvent for the maintenance liquid.

The pKa value of the basic compound used in the invention is preferably in the range of from 6.0 to 8.5, more preferably from 6.5 to 8.4, and still more preferably from 6.8 to 8.3, from the viewpoint that the maintenance liquid effectively exhibits a pH buffering ability in the pH range of from 6.5 to 8.4.

Examples of the basic compound that satisfies the above-described conditions include the following specific compounds.

Cacodylic acid (pKa: 6.2)

2,2-Bis (hydroxymethyl)-2,2′,2″-nitrotriethanol (pKa: 6.5)

Pyperazine-N,N′-bis-(2-ethane sulfuric acid) (pKa: 6.8)

Phosphoric acid (pKa 2: 6.86)

Imidazole (pKa: 7.0)

N′-2-hydroxyethylpyperazine-N′, 2-ethane sulfuric acid (pKa: 7.6)

N-methylmorphorine (pKa: 7.8)

Triethanolamine (pKa: 7.8)

Hydrazine (pKa: 8.11)

Trishydroxymethylaminomethane (pKa: 8.3)

The basic compound used in the invention may be any of inorganic compounds and organic compounds and is more preferably organic basic compounds in terms of easiness for obtaining a pKa in a desired range and solubility with respect to the maintenance solution. The basic compound may be a monobasic compound or a polybasic compound. The pKa value in the case of the organic basic compound is a pKa value of conjugate acid.

From the viewpoints of exhibiting the pH buffering ability while maintaining washing properties, the amount of the basic compound is 5 m mol/L or more, more preferably from 10 m mol/L to 100 m mol/L, and still more preferably from 10 m mol/L to 75 m mol/L.

Acidic Compound

The maintenance liquid of the invention preferably contains at least one acidic compound together with the basic compound. When the basic compound and the acidic compound are used in combination, pH buffering ability can be kept at a high level.

In particular, when a basic compound having a pKa value in the range of from 6.0 to 8.5 and the acidic compound are used in combination, a maintenance liquid having high buffer capacity in a preferable pH range of the maintenance liquid and also having particularly excellent pH stability is obtained.

In a case in which the maintenance liquid of the invention contains singly the basic compound without containing the acidic compound, the pH increases due to the basic compound. Therefore, in order to maintain a preferable pH range (from 6.0 to 8.5), the addition amount of the basic compound is limited to a low level. By the use of the acidic compound in combination with a basic compound, an appropriate amount of the basic compound can be added and a higher pH buffering capacity can be achieved.

The acidic compound used in the maintenance liquid of the invention is not particularly limited. As the acidic compound, any of inorganic acids or organic acids may be used. Examples of the inorganic acid include hydrochloric acid, sulfuric acid, sulfurous acid, nitric acid, and phosphoric acid. Examples of the organic acid include acetic acid, tartaric acid, salicylic acid, sulfosalicylic acid, and benzoic acid. The acidic compound used in the present invention is preferably an inorganic acid. As the acidic compound, any of weak acids or strong acids may be used. From the viewpoint of high pH buffering ability, strong acids are preferred.

The acidic compound may be used singly or in combination of two or more kinds thereof.

In view of a high pH buffering ability of the maintenance liquid, an additive amount of the acidic compound is preferably an acid equivalent amount of from 0.05 to 0.95 equivalents, more preferably from 0.10 to 0.90 equivalents, and still more preferably from 0.15 to 0.85 equivalents to the basic compound respectively. When a plurality of acidic compounds is used, it is preferred that a total amount of these acidic compounds is in the aforementioned range.

A preferable combination of the basic compound and the acidic compound in the invention is a combination of an organic basic compound having a pKa value in the range of 6.0 to 8.5 and inorganic acid.

Surfactant

The maintenance liquid of the invention may contain at least one surfactant as a surface tension regulator. As for the surfactant, any of nonionic surfactants, cationic surfactants, anionic surfactants, betaine surfactants or the like may be used. Preferable examples of the surfactant include anionic surfactants such as fatty acid salts, alkyl carboxylic acid salts, esters of alkyl sulfuric acid salts, alkyl sulfonic acid salts, alkyl benzene sulfonic acid salts, alkyl naphthalene sulfonic acid salts, dialkyl sulfosuccinic acid salts, esters of alkyl phosphoric acid salts, condensation products of formalin and naphthalene sulfonic acid, or esters of polyoxyethylenealkyl sulfuric acid salts; and nonionic surfactants such as polyoxyethylenealkyl ethers, polyoxyethylenealkyl aryl ethers, polyoxyethylene fatty acid esters, sorbitan fatty acid esters, polyoxyethylene sorbitan fatty acid esters, acetylene diol derivatives, polyoxyethylenealkyl amines, glycerol fatty acid esters, or oxyethyleneoxypropylene block copolymers.

Of these surfactants, acetylene diol derivatives, sodium alkyl carboxylate, and sodium alkyl sulfonate are more preferred in view of no occurrence of aggregation reaction with the ink.

The content of the surfactant in the maintenance liquid is preferably from 0.5% by mass to 10% by mass, and more preferably from 1% by mass to 3% by mass, with respect to a total mass of the maintenance liquid. If the content of the surfactant is in the range described above, the maintenance liquid has an advantage in washing properties.

Other Components

The maintenance liquid of the present invention may further contain other additives in addition to the above-described components, as needed. Examples of the other additives include additives such as an anti-fading agent, an emulsion stabilizer, a penetration accelerator, a UV absorbent, an antiseptic agent, an antifungal agent, a pH adjuster, a defoaming agent, or a viscosity modifier.

Properties or the Like of Maintenance Liquid

The maintenance liquid of the invention is preferably a liquid that does not cause aggregation at the time when the maintenance liquid is mixed with an ink composition used in the invention. This is because if aggregation is caused, components such as pigments in the ink composition are further solidified and stuck to an inkjet head or the like, whereby effects of the present invention is reduced.

The viscosity of the maintenance liquid at 20° C. is preferably from 1 mPa·s to 1000 mPa·s, more preferably from 1 mPa·s to less than 500 mPa·s, and still more preferably from 2 mPa·s to less than 100 mPa·s from the viewpoint of operability. The method of measuring viscosity in the invention is similar to the method described in the section of aggregation liquid.

The maintenance liquid of the invention is preferably a substantially colorless liquid that contains substantially no pigment.

A solid content of the maintenance liquid at 25° C. is not particularly limited. In view of preventing solid residues from being formed after cleaning, the solid content is preferably 5% by mass or less, and more preferably 2% by mass or less.

In the invention, from the viewpoint of an improvement of wettability and an improvement of permeability, other solvents may be used in combination with the organic solvent having an ether bond insofar as effects of the invention are not impaired. Examples of the other solvents that can be used in combination include water-soluble organic solvents, such as alcohols or polyhydric alcohols.

Specific examples of the alcohols include straight chain or branched chain alkyl alcohols, such as ethanol, butanol, and isopropanol. Specific examples of the polyhydric alcohols include alkane diols, such as ethylene glycol, propylene glycol, diethylene glycol, triethylene glycol, tetraethylene glycol, pentaethylene glycol, dipropyrene glycol, 2-butene-1,4-diol, 2-ethyl-1,3-hexanediol, 2-methyl-2,4-pentanediol, 1,2-octanediol, 1,2-hexanediol, 1,2-pentanediol, and 4-methyl-1,2-pentanediol and triols, such as glycerin, 1,2,4-butanetriol, and 1,2,6-hexanetriol.

In addition, 2-pyrrolidone, N-methyl-2-pyrrolidone, 1,3-dimethyl-2-imidazolidinone, formamide, acetamide, dimethylsulfoxide, sorbit (sorbitol), sorbitan, acetin, diacetin, triacetin, sulfolane, and the like can be used as the water-soluble organic solvent.

A total content of the organic solvent in the maintenance liquid of the invention is preferably 15% by mass or more, more preferably from 15% by mass to 90% by mass, and still more preferably from 15% by mass to 80% by mass in the maintenance liquid from the viewpoint of improving washability of the solid ink matter.

Method of Manufacturing Maintenance Liquid for Ink Jet Recording

A method of manufacturing a maintenance liquid for ink jet recording of the invention is:

A method of manufacturing a maintenance liquid for ink jet recording containing water and an organic solvent having an ether bond, in which the content of the organic solvent is from 15% by mass to 40% by mass with respect to a total mass of the maintenance liquid and the concentration of peroxide is 0.1 mmol/L or less and the method including:

a process for mixing water and the organic solvent having an ether bond; and a process for purifying by distillation in advance the organic solvent having an ether bond that is used in the process for mixing.

In the maintenance liquid for ink jet recording, obtained by such a manufacturing method, a change in pH over time is suppressed. As a result, the maintenance liquid exhibits excellent maintenance properties over a long period of time.

In the process for mixing water and the organic solvent having an ether bond (also referred to as “a mixing process”.), at least water and the organic solvent are mixed and further other ingredients may be mixed as required. Details of the other ingredients are the same as those described above with respect to the description of the maintenance liquid of the invention. A mixing ratio of the organic solvent, water, and the other ingredients is also as described above in the description of the maintenance liquid of the invention.

In the process for purifying by distillation beforehand the organic solvent having an ether bond that is used in the process for mixing (this process for purification is also referred to as “a distillation-purification process”), a method of distillation-purification process of the organic solvent is not particularly limited and known distillation and purification techniques can be applied. Distillation methods described in JP-A Nos. 10-57703, 10-57704, and 2003-10601 may also be applied.

In the manufacturing method of the invention, peroxides contained in the organic solvent having an ether bond can be completely or partially removed by carrying out the distillation-purification process and the concentration of peroxide of the maintenance liquid can be maintained at a lower level.

A concentration of peroxide in the organic solvent immediately after carrying out the distillation-purification process is preferably 0.25 mmol/L or less, more preferably 0.2 mmol/L or less, still more preferably 0.1 mmol/L or less, and still more preferably 0 mmol/L.

In the manufacturing method of the invention, the time elapsed from carrying out the distillation-purification process while the mixing process is preferably as short as possible. For example, by shortening the elapsed time between these two processes, generation of peroxide in the organic solvent distilled by purifying is suppressed. As a result, the concentration of peroxide in the maintenance liquid can be lowered.

Ink Set for Ink Jet Recording

An ink set for ink jet recording of the invention (hereinafter also referred to as “an ink set”) has the maintenance liquid for ink jet recording of the invention and at least one kind of an aqueous ink composition having a pH of from 7 to 10. By the ink set with such compositions, stable dischargeability can be maintained over a long period of time.

Aqueous Ink Composition

A pH (25° C.) of the aqueous ink composition (hereinafter also referred to as “an ink composition” or simply as “ink”) used in the ink set of the invention is from 7.0 to 10.0.

The ink composition contains at least one color material (colorant) and may contain polymer particles, a hydrophilic organic solvent, a surfactant, water, and other additives as required.

Color Material

The ink used in the ink set of the invention may contain known dyes, pigments, or the like as a color material without particular limitation. The ink used in the invention may be prepared in the form of a yellow-colored ink, a magenta-colored ink, a cyan-colored ink, a black-colored ink, a red-colored ink, a green-colored ink, a blue-colored ink, or the like by changing a color of the color material.

The color material is preferably a pigment from the viewpoint of ink coloring properties.

Pigment

The ink composition used in the invention contains at least one pigment.

The pigment used in the invention is not specifically limited, and may be a hitherto known organic pigment or inorganic pigment.

Examples of the organic pigment include azo pigments, polycyclic pigments, dye chelates, nitro pigments, nitroso pigments and aniline black. Among these, azo pigments, polycyclic pigments or the like are more preferable.

Examples of the azo pigments include an azo lake pigment, an insoluble azo pigment, a condensed azo pigment, and a chelate azo pigment.

Examples of the polycyclic pigments include a phthalocyanine pigment, a perylene pigment, a perynone pigment, an anthraquinone pigment, a quinacridone pigment, a dioxazine pigment, an indigo pigment, a thioindigo pigment, an isoindolinone pigment, and a quinophtharone pigment.

Examples of the dye chelates include basic dye chelate pigments and acid dye chelate pigments.

Examples of the inorganic pigments include titanium oxide, iron oxide, calcium carbonate, barium sulfate, aluminum hydroxide, barium yellow, cadmium red, chrome yellow, and carbon black. Among these pigments, carbon black is particularly preferable. The carbon black may be, for example, a carbon black manufactured by a known method such as a contact method, a furnace method or a thermal method.

The pigment may be used singly or in combination of two or more thereof, each of which may be selected from the above classes of pigments and may belong to the same class as each other or different classes from each other.

The pigment used in the invention is preferably used as water dispersions of at least one pigment selected from the following (1) to (4), from the viewpoint of liquid stability and ejection stability.

(1) An encapsulated pigment: a polymer emulsion of a pigment embedded in each water-insoluble resin fine particle; more specifically, water dispersions of pigment particles each coated with a hydrophilic water-insoluble resin so as to impart hydrophilic properties to the surface of the pigment particle.

(2) A self-dispersible pigment: a pigment having at least one hydrophilic group on a surface thereof and exhibiting at least one of water-dispersibility or water-solubility in the absence of a dispersant; more specifically, a pigment prepared by subjecting the surfaces of pigment particles (such as carbon black particles) to an oxidizing treatment so as to impart hydrophilic properties to the pigment particles and so as to enable the pigment itself to disperse in water.

(3) A resin dispersed pigment: a pigment dispersed using a water-soluble polymer compound having a weight average molecular weight of 50,000 or less.

(4) A surfactant-dispersed pigment: a pigment dispersed using a surfactant.

Among these pigments, the encapsulated pigment (1), the self-dispersible pigment (2) and the resin dispersed pigment (3) are preferable, and the encapsulated pigment (1) and the resin dispersed pigment (3) are particularly preferable.

A content of the pigment in a total content of the ink composition used in the invention is preferably from 0.1% by mass to 15% by mass, more preferably from 0.5% by mass to 12% by mass, and still more preferably from 1% by mass to 10% by mass from the viewpoint of color development properties, graininess, ink stability, and discharge reliability.

(1) Encapsulated Pigment

The encapsulated pigment is described in detail.

The resin used in the encapsulated pigment is not specifically limited. As the resin, however, it is preferable to use a hydrophilic and water-insoluble polymer compound that is self-dispersible or dissolvable in a mixed solvent of water and a water-soluble organic solvent and that has an anionic (acidic) group. The resin is preferably a resin that can dissolve in an organic solvent to form a solution.

In general, the number average molecular weight of the resin is preferably in the range of about 1,000 to about 100,000, and particularly preferably in the range of about 3,000 to about 50,000. When the number average molecular weight of a resin is within the above ranges, the resin can exhibit sufficient function as a cover layer on pigment particles or as a coated layer of an ink composition. The resin is preferably used in the form of an alkali metal salt or an organic amine salt.

The resin used for the encapsulated pigment may be, for example, a material having an anionic group, and examples thereof include thermoplastic, thermosetting, or modified resins that are composed of the following types of resin: a polymer compound such as an acrylic resin, an epoxy resin, a polyurethane resin, a polyether resin, a polyamide resin, an unsaturated polyester resin, a phenol resin, a silicone resin, or a fluorine resin; a polyvinyl resin such as polyvinyl chloride, polyvinyl acetate, polyvinyl alcohol or polyvinyl butyral; a polyester resin such as an alkyd resin or a phthalic acid resin; an amino resin such as a melamine resin, a melamine-formaldehyde resin, an amino alkid co-condensed resin, or a urea resin; and copolymers or mixtures of two or more of these resins.

Of the above resins, an anionic acrylic resin can be obtained, for example, by polymerizing, in a solvent, an acrylic monomer having an anionic group (hereinafter, referred to as an anionic group-containing acrylic monomer) and, optionally, one or more other monomers copolymerizable with the anionic group-containing acrylic monomer. Examples of the anionic group-containing acrylic monomer include an acrylic monomer having one or more anionic groups selected from the group consisting of a carboxylic group, a sulfonic acid group and a phosphonic group. Among these acrylic monomers, an acrylic monomer having a carboxyl group is especially preferable.

Examples of the acrylic monomer having a carboxyl group include acrylic acid, methacrylic acid, crotonic acid, ethacrylic acid, propylacrylic acid, isopropylacrylic acid, itaconic acid and fumaric acid. Among these monomers, acrylic acid and methacrylic acid are preferable.

An encapsulated pigment can be manufactured by a conventional physical and/or chemical method by using the above components. According to a preferable embodiment of the present invention, the encapsulated pigment can be manufactured by the methods described in JP-A Nos. 9-151342, 10-140065, 11-209672, 11-172180, 10-25440, or 11-43636.

Specifically, examples of the method for manufacturing the encapsulated pigment include a phase-inversion emulsification method and an acid precipitation method described in JP-A Nos. 9-151342 and 10-140065.

The phase-inversion emulsification method is a self-dispersion (phase-inversion emulsification) method, which may basically include a process of dispersing a fused mixture of a self-dispersible or water-soluble resin and a pigment in water. The fused mixture may contain the above-described curing agent or polymer compound as a component thereof. The “fused mixture” refers to a state in which undissolved components are mixed, or a state in which dissolved components are mixed, or a state including both of the above states.

For more detailed information about the phase-inversion emulsification method and the acid precipitation method, JP-A Nos. 9-151342 and 10-140065 can be referred to.

More specifically, the resin constituting the encapsulated pigment is preferably a hydrophilic and water-insoluble resin having a hydrophilic structural unit (a) and a hydrophobic structural unit (b). The water-insoluble resin may further contain other structural units not included in the hydrophilic structural unit (a) and the hydrophobic structural unit (b) as required. The details of the hydrophilic structural unit (a), the hydrophobic structural unit (b), the other structural units, and the resin constituting the encapsulated pigment can be referred to the description of Paragraphs 0049 to 0085 of JP-A No. 2010-013505.

(2) Self-Dispersible Pigment

The self-dispersing pigment refers to a pigment to the surface of which a lot of hydrophilic functional groups and/or salts thereof (hereinafter, referred to as dispersibility-imparting groups) are bonded directly or through an alkyl group, an alkyl ether group, an aryl group, or the like, whereby the pigment is dispersible in an aqueous medium without a dispersant. Herein, the term “dispersible in an aqueous medium without a dispersant” refers to the state in which a pigment is dispersible in an aqueous medium without a dispersant for dispersing the pigment.

The ink containing a self-dispersible pigment as a colorant (color material) is not necessary to contain the above-described dispersant that is contained to disperse an ordinary pigment. As a result, there are almost no chances that foam formation is induced by reduction in defoaming properties arising from a dispersant. Therefore, an ink having excellent ejection properties is easy to be prepared.

Examples of the dispersibility-imparting groups that are bonded to the surface of the self-dispersible pigment include —COOH, —CO, —OH, —SO₃H, —PO₃H₂, quaternary ammonium, and salts thereof. These groups can be produced by subjecting the pigment as a raw material to a physical processing or a chemical processing so that a dispersibility-imparting group or active species having a dispersibility-imparting group can be bonded (grafted) to the surface of the pigment. Examples of the physical processing include a vacuum plasma processing. Examples of the chemical processing include a wet oxidation process in which a surface of a pigment is oxidized with an oxidant in water, and a process of bonding a carboxyl group through a phenyl group by bonding p-aminobenzoic acid to a surface of a pigment.

In the present invention, preferable examples of the self-dispersible pigments include those that are surface-treated by oxidation treatment using hypohalous acid and/or a salt of hypohalous acid, or by ozone oxidation treatment. The self-dispersible pigments are also available from commercialized products. Examples of the commercialized products include MICROJET CW series (trade name, produced by Orient Chemical Industries Co., Ltd.), CAB-O-JET series (trade name, produced by Cabot Corporation).

(3) Resin Dispersible Pigment

In addition to the above-described encapsulation method, as an example of a method of manufacturing the “pigment particles covered with water-insoluble resin” in the invention, pigment dispersion can be manufactured by dispersing the pigment particles using a water-insoluble resin as a dispersant.

In such a way, pigment particles with a microparticulated size can be formed, and high dispersion stability after dispersion can be attained. In this case, the entire surface of the pigment particles is not necessarily covered with the water-insoluble resin, but at least a part of the pigment particles may be covered with the water-insoluble resin, as occasion demands.

The pigment dispersion can be manufactured, for example, using the phase-inversion emulsification method as described in the above. More specifically, after preparation of a fluid dispersion by mixing and dispersing the pigment, the above-described water-insoluble resin (as a dispersant), water, and a water-insoluble volatile solvent, the water-insoluble volatile solvent is removed from the resultant dispersion. At this time, a part or all of the anionic groups of the water-insoluble resin may be neutralized by adding a basic compound. An excellent dispersibility can be attained by controlling the neutralization. Examples of the basic compound include sodium hydroxide.

Further, at this time, an alkylene oxide adduct of glycerol, which will be described later, may be added together with the water-insoluble volatile solvent.

The dispersion can be performed using known methods of agitating and dispersing after mixing desired components, or using known agitating and dispersing machines. The dispersion can be performed, for example, by using a ball mill, a roll mill, a bead mill, a high-pressure homogenizer, a high-speed agitating dispersion machine and a ultrasonic homogenizer.

Dispersant for Pigment

At the time of manufacturing the pigment dispersion, the water-insoluble resin can be used as a dispersant. At this time, the other dispersant for pigment in addition to the water-insoluble resin may be used together.

The other dispersant for the pigment can be appropriately selected from the compounds having a function for dispersing pigment in an aqueous phase. Examples of dispersants for pigment include a nonionic compound, an anionic compound, a cationic compound and amphoteric compound.

For example, as dispersants, homopolymers or copolymers of monomers having an α, β-ethylenically unsaturated group and the like are exemplified. Examples of the monomers having an α, β-ethylenically unsaturated group include ethylene, propylene, butene, pentene, hexene, vinyl acetate, allyl acetate, acrylic acid, methacrylic acid, crotonic acid, crotonic acid ester, itaconic acid, itaconic acid monoester, maleic acid, maleic acid monoester, maleic acid diester, fumaric acid, fumaric acid monoester, vinyl sulfonic acid, styrene sulfonic acid, sulfonated vinyl naphthalene, vinyl alcohol, acrylamide, methacryloxy ethyl phosphate, bismethacryloxyethyl phosphate, methacryloxyethylphenyl acid phosphate, ethyleneglycol dimethacrylate, diethyleneglycol dimethacrylate, styrene, styrene derivatives such as α-methyl styrene, vinyltoluene; vinyl cyclohexane, vinyl naphthalene, vinyl naphthalene derivatives, an alkyl acrylate which may have an aromatic substituent, a phenyl acrylate, an alkyl methacrylate which may have an aromatic substituent, a phenyl methacrylate, a cycloalkyl methacrylate, an alkyl crotonate, a dialkyl itaconate, a dialkyl maleate, vinyl alcohol, and derivatives of the above compounds.

Homopolymers or copolymers of monomers having the α, β-ethylenically unsaturated group may be used as a polymer dispersant.

Examples of the polymer dispersants include an alkyl acrylate-acrylic acid copolymer, an alkyl methacrylate-methacrylic acid copolymer, a styrene-alkyl acrylate-acrylic acid copolymer, styrene-phenylmethacrylate-methacrylic acid copolymer, styrene-cyclohexyl methacrylate-methacrylic acid copolymer, styrene-styrene sulfonic acid copolymer, styrene-maleic acid copolymer, styrene-methacrylic acid copolymer, styrene-acrylic acid copolymer, vinyl naphthalene-maleic acid copolymer, vinyl naphthalene-methacrylic acid copolymer, vinyl naphthalene-acrylic acid copolymer, polystyrene, polyester and polyvinyl alcohol.

Water-Insoluble Volatile Solvent

When the pigment dispersion is prepared, at least one water-insoluble volatile solvent may be used. Since the water-insoluble volatile solvent has less influence on the dispersibility, the water-insoluble volatile solvent can be removed finally, while maintaining a good dispersibility in the dispersion step, so that the dispersion can be thickened while maintaining a good dispersed state, and the pigment dispersion with an excellent storability over a long period of time can be obtained. Moreover, when an ink composition is prepared and used for recording, an image recording with a high ink ejection stability and suppressed curl of a recording medium can be attained.

The term “water-insolubility” refers to the characteristic such that when a solvent is mixed with pure water in the same amount of the solvent, and the mixture is gently stirred at one atmospheric pressure and 20° C., the mixture does not appear to be homogeneous, even after the flow due to stirring is ceased. The solubility with respect to water at 20° C. is preferably 80 g/100 ml or less, and more preferably 50 g/100 ml or less.

The “volatility” of a solvent means that the solvent has a boiling point of 200° C. or less, and preferably 150° C. or less.

The water-insoluble volatile solvent may be appropriately selected from organic solvents with water-insolubility and volatility. Specific examples of the water-insoluble volatile solvents include ketone-based solvents (for example, methyl ethyl ketone, diethyl ketone and the like), and ether-based solvents (for example, dibutyl ether and the like). In particular, from the viewpoint of the dispersion stability, ketone-based solvents are preferable, and methyl ethyl ketone is particularly preferable.

The use amount of the water-insoluble volatile solvent is preferably from 10% by mass to 1,000% by mass, more preferably from 50% by mass to 800% by mass, and still more preferably from 100% by mass to 500% by mass with respect to the use amount of the alkyleneoxide adduct of glycerol, in view of favorable dispersibility and stability after dispersion, and the ink ejection stability when the water-insoluble volatile solvent is used for an ink composition for recording, and suppression of curl of a recorded medium.

The water-insoluble volatile solvent as described in the above is preferably removed from the liquid after the pigment is dispersed. In such a way, the amount of the water-insoluble volatile solvent which becomes unnecessary finally is reduced, and a thickened pigment dispersion can be obtained, while the dispersibility of pigment and storability of the dispersion can be maintained over a long period of time. Further, when the water-insoluble volatile solvent is used for preparation of pigment ink, and the ink is used for recording an image, the ink ejection stability can be attained, and occurrence of curl of a recording medium can be prevented.

The removal of the water-insoluble volatile solvent can be performed by conventional methods including a drying method such as heating or air blowing, or distillation under reduced pressure, and the water-insoluble volatile solvent is distilled away from the dispersion obtained by the dispersion process, so that the dispersion is thickened and phase-inverted to an aqueous system (phase-inversion emulsification). In this case, when the water-insoluble resin is used as a dispersant for pigment; a dispersion of pigment particles, in which the surface of the pigment particles is covered with the water-insoluble resin, can be obtained.

It is preferable that, after the removal process of the water-insoluble volatile solvent, the water-insoluble volatile solvent is substantially removed from the prepared pigment dispersion. Specifically, the remaining amount of the water-insoluble volatile solvent in the pigment dispersion is preferably 5% by mass or less with respect to the addition amount of the water-insoluble volatile solvent at the time of dispersing, from the viewpoint of the thickening of the pigment dispersion, the ejection stability when an ink composition using the water-insoluble volatile solvent is used, and the suppression of occurrence of curl of a recording medium. The remaining amount of the water-insoluble volatile solvent in the pigment dispersion is preferably 1% by mass or less, and more preferably 0.1% by mass or less.

In the invention, when the pigment is used as a pigment dispersion in which the pigment is dispersed with the water-insoluble resin, a mass ratio (pigment:dispersant) of the pigment and the water-insoluble resin is preferably from 100:25 to 100:140 and more preferably from 100:25 to 100:50. When the ratio of the pigment and the dispersant is 100:25 or more, dispersion stability and rub (scratch) resistance tend to be improved. When the ratio of the pigment and the dispersant is 100:140 or lower, the dispersion stability tends to be improved.

An average particle diameter of pigment particles dispersed in the pigment dispersion is preferably in the range of from 30 nm to 200 nm, and more preferably in the range of from 50 nm to 150 nm. When the average particle diameter of pigment particles is 30 nm or more, the production suitability is improved, and when the average particle diameter of pigment particles is 200 nm or less, the storability of the dispersion becomes favorable. A size distribution of the pigment particles covered with resin is not specifically restricted, and either particles having a broad particle diameter distribution or particles having a mono-dispersed particle diameter distribution may be used.

Further, the average particle diameter and of the particle size distribution of pigment particles can be obtained by measuring the volume average particle diameter by a dynamic light scattering method using NANOTRAC particle size distribution measuring device UPA-EX150 (trade name, manufactured by Nikkiso Co., Ltd.).

Although a content of the “pigment covered with water-insoluble resin” in the ink composition of the present invention is not specifically restricted, the content is preferably from 0.05% by mass to 30% by mass, more preferably from 0.1% by mass to 20% by mass, and still more preferably from 0.15% by mass to 15% by mass in terms of solid content. When the content is 0.05% by mass or more, the phenomena that ink coloration (coloring properties) becomes insufficient can be effectively prevented. Further, when the content is 30% by mass or less, an increase in the viscosity of ink can be effectively suppressed and deterioration of the ink ejection stability and the like can be effectively prevented.

Polymer Particles

The ink composition used in the invention preferably contains at least one kind of polymer particles. Fixing properties of the ink can be improved by containing the polymer particles

The polymer particles are used preferably as polymer latex in which the particles are dispersed in water.

Examples of polymer particles or polymer latexes that can be used in the invention include acrylic resins, vinyl acetate resins, styrene-butadiene resins, vinyl chloride resins, acrylic-styrene resins, butadiene resins, styrene resins, cross-linked acrylic resins, cross-linked styrene resins, benzoguanamine resins, phenol resins, silicone resins, epoxy resins, urethane resins, paraffin resins, and fluorine resins. Preferable examples of the polymer include acrylic resins, acrylic-styrene resins, styrene resins, cross-linked acrylic resins, and cross-linked styrene resins.

A weight average molecular weight of the polymer particles used in the invention is preferably from 10,000 to 200,000, and more preferably from 100,000 to 200,000.

An average particle diameter of the polymer particles used in the present invention is preferably from 10 nm to 1 μm, more preferably from 10 nm to 200 nm, still more preferably from 20 nm to 100 nm and still more preferably from 20 nm to 50 nm.

A glass transition temperature (Tg) of the polymer particles used in the invention is preferably 50° C. or more. Incorporation of the polymer particles having a Tg of 50° C. or more makes it possible to effectively increase fixing property of the ink composition on a recording medium and rub resistance. The Tg of the polymer particles is more preferably from 50° C. to 180° C., and still more preferably from 70° C. to 170° C.

The addition amount of the polymer particles is preferably from 0.5 to 20% by mass, more preferably from 3 to 20% by mass, and still more preferably from 5 to 15% by mass based on the ink composition.

A size distribution of the polymer particles is not specifically restricted, and either particles having a broad particle diameter distribution or particles having a mono-dispersed particle diameter distribution may be used. Further, two or more kinds of polymer particles each having mono-disperse particle distribution may be used.

Solid Wetting Agent

The ink composition used in the invention may contain a solid wetting agent.

The solid wetting agent used in the invention refers to a water-soluble compound that has a water-retaining function, and that is solid at 25° C. The solid wetting agent has high water-retaining function whereby an ink can be prevented from dryness and solidification which are not desirable for the ink. As a result, in the invention, the solid wetting agent can be favorably used in the ink composition.

As the solid wetting agent usable in the invention, compounds commonly used for water-based ink compositions can be used without any modification, and, more specifically, urea, and urea derivatives, sugars, and polyhydric alcohols such as sugar alcohols, hyaluronic acids, trimethylol propane or 1,2,6-hexanetriol are exemplified.

Examples of the urea derivatives include compounds in which the hydrogen atom on the nitrogen of urea is substituted with an alkyl group or an alkanol, thiourea, or compounds in which the hydrogen atom on the nitrogen of thiourea is substituted with an alkyl group or an alkanol. More specifically, N,N-dimethyl urea, thiourea, ethyleneurea, hydroxyethyl urea, hydroxybutyl urea, ethylene thiourea, diethyl thiourea, and the like are exemplified.

Examples of the sugars include monosaccharide, disaccharide, oligosaccharides (including trisaccharides and tetraaccharides) and polysaccharides, specifically, glucose, mannose, fructose, ribose, xylose, arabinose, galactose, aldonic acid, glucitol, (sorbit), maltose, cellobiose, lactose, sucrose, trehalose, maltotriose are exemplified. Here, polysaccharides means sugars in a broad sense, and, are used for including substances such as alginic acid, α-cyclodextrin, or cellulose, which are widely distributed in nature. Further, derivatives of these sugars include reduced sugars of the above-described sugars (for example, sugar alcohol), and oxidized sugars (sugar acids) (for example, aldonic acid, uronic acid, amino acid, thiosugar, and the like). In particular, sugar alcohol is desirable, and specifically, maltitol, sorbitol, xylitol, and the like are exemplified. As hyaluronate, commercially available sodium hyaluronate (1% aqueous solution) (molecular weight 350,000) may be used.

A content of the solid wetting agent in the ink composition used in the invention is preferably from 1.0% by mass to less than 20.0% by mass, more preferably from 2.0% by mass to less than 15.0% by mass, and still more preferably from 3.0% by mass to less than 10.0% by mass, from the viewpoint of further increasing the wiping off property.

Herein, when the ink composition used in the invention contains two or more solid wetting agents, it is preferred that a total content of these two or more solid wetting agents is in the above range.

Water-Soluble Organic Solvent

The ink composition used in the invention contains water as a solvent and preferably contains at least one kind of water-soluble organic solvents.

Examples of the water-soluble organic solvents include polyhydric alcohols such as glycerol, 1,2,6-hexanetriol, trimethylol propane, alkanediols such as ethylene glycol, propylene glycol, diethylene glycol, triethylene glycol, tetraethylene glycol, pentaethylene glycol, dipropylene glycol, 2-butene-1,4-diol, 2-ethyl-1,3-hexanediol, 2-methyl-2,4-pentanediol, 1,2-octanediol, 1,2-hexanediol, 1,2-pentanediol, and 4-methyl-1,2-pentanediol; alkyl alcohols having 1-4 carbon atoms, such as ethanol, methanol, butanol, propanol or isopropanol; glycol ethers such as ethyleneglycol monomethylether, ethyleneglycol monoethylether, ethyleneglycol monobutylether, ethyleneglycol monomethylether acetate, diethyleneglycol monomethylether, diethyleneglycol monoethylether, diethylene glycol mono-n-propylether, ethyleneglycol mono-iso-propylether, diethylene glycol mono-iso-propylether, ethyleneglycol mono-n-butylether, ethyleneglycol mono-t-butylether, diethyleneglycol mono-t-butylether,l-methyl-1-methoxybutanol, propyleneglycol monomethylether, propyleneglycol monoethylether, propyleneglycol mono-t-butylether, propyleneglycol mono-n-propylether, propyleneglycol mono-iso-propylether, dipropyleneglycol monomethylether, dipropyleneglycol monoethylether, dipropyleneglycol mono-n-propylether or dipropyleneglycol mono-iso-propylether; 2-pyrrolidone, N-methyl-2-pyrrolidone, 1,3-dimethyl-2-imidazolizinone, formamide, acetamide, dimethylsulfoxide, sorbit, sorbitan, acetin, diacetin, triacetin or sulfolane. These compounds may be used singly, or may be used in combination of two or more kinds thereof.

For the purpose of imparting a dryness preventive property or a wetting property, it is useful to use polyhydric alcohols. Examples of polyhydric alcohols include glycerin, ethylene glycol, diethylene glycol, triethylene glycol, propylene glycol, dipropylene glycol, tripropylene glycol, 1,3-butanediol, 2,3-butanediol, 1,4-butanediol, 3-methyl-1,3-butanediol, 1,5-pentanediol, tetraethylene glycol, 1,6-hexanediol, 2-methyl-2,4-pentanediol, polyethylene glycol, 1,2,4-butanetriol and 1,2,6-hexanetriol. These compounds may be used singly or may be used in combination of two or more kinds thereof. In view of penetrating property, it is desirable to use polyol compounds. Examples of polyol compounds include, for example, aliphatic diols such as 2-ethyl-2-methyl-1,3-propanediol, 3,3-dimethyl-1,2-butanediol, 2,2-diethyl-1,3-propanediol, 2-methyl-2-propyl-1,3-propanediol, 2,4-dimethyl-2,4-pentanediol, 2,5-dimethyl-2,5-hexanediol, 5-hexene-1,2-diol or 2-ethyl 1,3-hexanediol. In particular, 2-ethyl-1,3-hexanediol or 2,2,4-trimethyl-1,3-pentanediol is preferable. These compounds may be used singly or may be used in combination of two or more kinds thereof.

Alkyleneoxide adducts of glycerol may be preferably used. As the alkyleneoxide adduct of glycerol, commercially available products may be used. Examples of the commercially available product include, as examples of polyoxy propylated glycerol (ether of polypropylene glycol and glycerol), SANNIX GP-250 (average molecular weight of 250), SANNIX GP-400 (average molecular weight of 400), and SANNIX GP-600 (average molecular weight of 600) (each trade names, manufactured by Sanyo Chemical Industries, Ltd.), LEOCON GP-250 (average molecular weight of 250), LEOCON GP-300 (average molecular weight of 300), LEOCON GP-400 (average molecular weight of 400) and LEOCON GP-700 (average molecular weight of 700) (each trade names, manufactured by Lion Corporation); and polypropylene triol glyc.triol type products having average molecular weight of 300 and average molecular weight of 700 (each manufactured by Wako Pure Chemical Industries, Ltd.)

From the viewpoint of imparting the dryness-preventive property and the wetting property, a content of the water-soluble organic solvent contained in the ink composition used in the invention is preferably from 1.0% by mass to 50% by mass, more preferably from 5.0% by mass to 40% by mass, and still more preferably from 10% by mass to 30% by mass with respect to the ink composition.

Water

Although the pigment dispersion used in the invention contains water, the quantity of water is not particularly restricted. In particular, a content of water is preferably from 10% by mass to 99% by mass, more preferably from 30% by mass to 80% by mass, and still more preferably from 50% by mass to 70% by mass.

Other Components

The ink composition used in the invention may contain other additives in addition to the above components. The other additives include, for example, known additives such as a surfactant, an ultraviolet absorber, an anti-fading agent, an antifungal agent, a pH adjuster, an antirust agent, an antioxidant, an emulsion stabilizer, an antiseptic agent, a defoaming agent, a viscosity adjustment agent, a dispersion stabilizer or a chelating agent.

The surfactant is used as a surface tension adjusting agent, and examples of the surfactant includes a nonionic surfactant, a cationic surfactant, an anionic surfactant and a betaine surfactant. In order to favorably eject inkjet droplets on a recording medium, the surface tension adjusting agent is added to an ink composition in such an amount that the surface tension of the ink composition used in the present invention is preferably adjusted to a range of 20 mN/m to 60 mN/m, more preferably from 20 mN/m to 45 mN/m, and still more preferably from 25 mN/m to 40 mN/m.

Although a content of the surfactant in the ink composition is not specifically restricted, the content is preferably 1% by mass or more, more preferably from 1% by mass to 10% by mass, and still more preferably from 1% by mass to 3% by mass.

Properties of Ink Composition

The surface tension of the ink composition used in the invention is preferably adjusted to a range of from 20 mN/m to 60 mN/m, more preferably from 20 mN/m to 45 mN/m, and still more preferably from 25 mN/m to 40 mN/m, from the viewpoint of discharge stability when the ink composition is applied to inkjet recording system.

A viscosity of the ink composition used in the invention at 20° C. is preferably from 1.2 mPa·s to 15.0 mPa·s, more preferably from 2 mPa·s to less than 13 mPa·s and still more preferably from 2.5 mPa·s to less than 10 mPa·s.

Aggregation Liquid

The ink set of the present invention preferably further include at least one aggregation liquid capable of forming an aggregate when the aggregation liquid is brought into contact with the ink composition.

The aggregation liquid contains at least one aggregating agent capable of forming an aggregate when the aggregating agent is brought into contact with the ink composition. Due to mixing of the ink composition and the aggregating agent on a recording medium, aggregation of pigments or the like that is stably existing as a dispersion in the ink composition is accelerated. The aggregating agent is preferably at least one of materials selected from the group consisting of a cationic polymer, an acidic compound and a polyvalent metal salt from the viewpoint of image quality to be formed.

Polymers having a primary-, secondary- or tertiary-amino group or a quaternary ammonium salt group as the cationic group can be preferably used as the cationic polymer.

Preferable examples of the cationic polymer include: polymers that are obtained as a homopolymer of a monomer (cationic monomer) having a primary-, secondary- or tertiary-amino group, salts thereof, or a quaternary ammonium salt group; and polymers that are obtained as a copolymer or a condensation polymer of the cationic monomer and other monomer (non-cationic monomer). The polymers can be used in any form of a water-soluble polymer or water dispersible latex particles.

Specifically, the cationic polymer may be selected from poly (vinylpyridine) salts, polyalkylaminoethylacrylate, polyalkylaminoethylmethacrylate, poly (vinylimidazole), polyethyleneimine, polybiguanide, polyguanide, a copolymer containing an epihalohydrin derivative and an amine derivative as polymer components, a combination of these polymers, or the like.

A content of the cationic polymer in the aggregation liquid is preferably 5% by mass to 95% by mass, and more preferably 10% by mass to 80% by mass with respect to a total amount of the aggregation liquid from the viewpoint of aggregation effects.

Examples of the aggregation liquid containing an acidic compound include a liquid that can generate an aggregate by changing a pH of the ink composition. Herein, the pH of the aggregation liquid at 25° C. is preferably 1 to 6, more preferably 2 to 5, and still more preferably 3 to 5 from the viewpoint of the aggregation rate of the ink composition. Herein, the pH of the ink composition used in the ink application process at 25° C. is preferably 7.5 or more, and more preferably 8 or more.

In particular, in preferable embodiments, the pH (25° C.) of the ink composition is 7.5 or more and the pH (25° C.) of the aggregation liquid is from 3 to 5 from the viewpoint of improvements in image density and image resolution, and speed up of ink jet recording.

The components for the aggregation can be used singly or in combination of two or more kinds.

Examples of the acidic compound include compounds having a phosphoric acid group, a phosphonic acid group, a phosphinic acid group, a sulfuric acid group, a sulfonic acid group, a sulfinic acid group, or a carboxyl group, or salts thereof (e.g., polyvalent metal salts). Among the above, from the viewpoint of the aggregation rate of the ink composition, the compounds having a phosphoric acid group or a carboxyl group are more preferable, and the compounds having a carboxyl group are still more preferable.

The compounds having a carboxyl group are preferably selected from polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furan carboxylic acid, pyridine carboxylic acid, coumalic acid, thiophene carboxylic acid, nicotinic acid, derivatives thereof, or salts thereof (e.g., polyvalent metal salts). These compounds may be used singly or in combination of two or more thereof.

A content of the acidic compound in the aggregation liquid is preferably from 5% by mass to 95% by mass, and more preferably from 10% by mass to 80% by mass, with respect to a total amount of the aggregation liquid from the viewpoint of the aggregation effects.

One preferable example of the aggregation liquid that improves high-speed aggregation properties include an aggregation liquid to which a polyvalent metal salt is added. Examples of the polyvalent metal salt include alkaline earth metals of the second group of the periodic table (e.g., magnesium and calcium), the transition metals of the third group of the periodic table (e.g., lanthanum), cation of the 13th group of the periodic table (e.g., aluminum), and salts of lanthanides (e.g., neodymium). Carboxylate (for example, salts of formic acid, acetic acid, or benzoic acid), nitrate, chloride, and thiocyanate are preferable as the salts of metals. Among the above, calcium salts or magnesium salts of carboxylic acid (for example, salts of formic acid, acetic acid, or benzoic acid), calcium salts or magnesium salts of nitric acid, calcium chloride, magnesium chloride, and calcium salts or magnesium salts of thiocyanic acid are preferable.

A content of the metal salt in the aggregation liquid is preferably in the range of 1% by mass to 10% by mass, more preferably in the range of 1.5% by mass to 7% by mass, and still more preferably in the range of 2% by mass to 6% by mass.

A viscosity of the aggregation liquid is preferably in the range of 1 mPa·s to 30 mPa·s, more preferably in the range of 1 mPa·s to 20 mPa·s, still more preferably in the range of 2 mPa·s to 15 mPa·s, and still more preferably in the range of 2 mPa·s to 10 mPa·s from the viewpoint of the aggregation rate of the ink composition. The viscosity is measured under conditions of a temperature of 20° C. using VISCOMETER TV-22 (trade name, manufactured by TOKI SANGYO CO. LTD).

A surface tension of the aggregation liquid is preferably from 20 mN/m to 60 mN/m, more preferably from 20 mN/m to 45 mN/m, and still more preferably from 25 mN/m to 40 mN/m from the viewpoint of the aggregation rate of the ink composition. The surface tension is measured under conditions of a temperature of 25° C. using AUTOMATIC SURFACE TENSIOMETER CBVP-Z (trade name, manufactured by Kyowa Interface Science Co., LTD.).

Image Forming Method

The image forming method, which is one aspect of the invention, is a method using the above-described ink set for inkjet recording, and further the method includes an ink application process of applying an aqueous ink composition onto a recording medium by discharging the ink composition from an ink jet head, and an ink removal process of removing a solid ink matter adhered to the ink jet head by the above-described maintenance liquid.

Due to the processes, the image forming method of image forming method makes it possible to form a high-quality image.

The image forming method of the invention may have other processes as required. Examples of the other processes include an aggregating liquid supply process for supplying the aggregating liquid onto the recording medium.

Ink Application Process

The ink application process in the invention includes discharging the aqueous ink composition from an ink jet head to apply ink onto a recording medium. Details of the composition, preferable embodiments or the like of the aqueous ink composition to be used in this process are the same as those described above.

Examples of the recording medium include known image receiving materials, i.e., regular paper, resin coated paper, exclusive inkjet paper, film, electrophotography-shared paper, cloth, glass, metal, and porcelain.

The ink jet method for discharging the aqueous ink composition from an ink jet head is not particularly limited. Known methods, such as a charge control method in which ink is discharged utilizing electrostatic attraction force, a drop on demand method utilizing a vibration pressure of a piezoelectric element (pressure pulse method), an acoustic ink jet method including converting electric signals to acoustic beams, irradiating ink with the same, and discharging the ink utilizing the radiation pressure, or a thermal ink jet method (BUBBLE JET (registered trademark)) including heating ink to form bubbles, and utilizing the generated pressure, may be acceptable.

The ink jet recording method also includes other methods such as a method of injecting a large number of small droplets of a low density ink that is referred to as a photo ink, a method for improving image quality using two or more inks having substantially the same hue and different densities, or a method using a colorless and transparent ink.

Known ink jet heads can be used for the ink jet head (hereinafter also referred to as a “head”. Examples of the head include continuous types and dot on demand types. In a thermal head among the dot on demand types, a type, which has an operating valve for discharging as described in JP-A No. H9-323420 is preferable. As a piezoelectric head, heads disclosed in, for example, EP-A-0277703, EP-A-0278590, and the like can be used. The head is preferably a head having a temperature control function in such a manner as to control the temperature of the ink. In an ink discharging process, the ink temperature is preferably controlled so that the ink viscosity varies within ±5%. The head is preferably operated at a drive frequency of 1 to 500 kHz. The shape of the nozzle does not necessarily need to be circular but an oval shape, a rectangular shape, and the like may be acceptable. The diameter of the nozzle is preferably in the range of from 10 to 100 μm. An opening portion of the nozzle is not always a perfect circle. In such a case, supposing a circle equivalent to the area of the opening portion, the nozzle diameter is defined as the diameter of the circle.

The nozzle surface of the head is preferably subjected to ink repellent treatment in order to suppress ink adhesion. Water repellent properties become particularly favorable by covering the nozzle surface with a perfluoro polymer, such as PTFE, PFA, or FEP.

A temperature of ink at the time of discharging the ink is preferably 30° C. or more and more preferably 35° C. or more from the viewpoint of improving the maintenance properties. From the viewpoint of ink stability and discharge reliability, the ink temperature is preferably 70° C. or lower.

In the image forming method of the invention, it is preferable to further provide a process for drying by heating the ink on the recording medium after the ink application process. The ink aggregation rate can be increased by heating-drying the ink after the ink application process. The drying by heating can be carried out by the same measure as that in a process for drying by heating the aggregation liquid described later.

The image forming method of the invention preferably further has a process for fixing images recorded by application of the ink, by heating with press the images in order to increase rub resistance of the images.

The heating process is preferably carried out at a temperature equal to or higher than the minimum film forming temperature (MFT) of the polymer particles in the images. Due to heating of the images to a temperature equal to or higher than MFT, the polymer particles form a film and the images are strengthened.

The method of heating with press is not particularly limited. Favorable examples thereof include a method of passing an image through a pair of heating and pressing rollers or the like.

Ink Removal Process

An ink removal process in the invention includes removing a solid ink matter that is derived from an aqueous ink composition and adhered to an ink jet head using the maintenance liquid. Details of the composition, preferable embodiments or the like of the maintenance liquid that is used in this process are the same as those described above.

In the ink removal process, in order to remove the solid ink matter from the nozzle surface of the head, the maintenance liquid is applied to the head (e.g., a periphery of the head and an ink flow path: hereinafter also referred to as “a head or the like”). By applying the maintenance liquid to the head or the like, the solid ink matter is dissolved or swollen.

The application of the maintenance liquid is carried out, for example, by discharging by ink jetting, coating with a roller, or spraying.

Before or after applying the maintenance liquid, the solid ink matter is preferably removed by scratching with a blade or wiping out with a cloth or a paper. Examples of preferable methods include a method of scratching off the solid ink matter by wiping the nozzle surface with a wiper blade after applying the maintenance liquid, a method of removing the solid ink matter using a wind pressure or a liquid pressure of the maintenance liquid, and a method of wiping off the solid ink matter with a cloth or a paper.

The material of the wiper blade is preferably rubber having elasticity and specific examples include butyl rubber, chloroprene rubber, ethylene propylene rubber, silicone rubber, urethane rubber, and nitrile rubber. In order to impart ink repellent properties to the wiper blade, a wiper blade coated with fluororesin or the like may be used.

An application amount of the maintenance liquid is not particularly limited insofar as the solid ink matter can be dissolved, swollen, or the like; and the application amount is preferably from 1 g/m² to 100 g/m².

Aggregation Liquid Application Process

The aggregation liquid application process used in the invention includes applying the aggregation liquid onto a recording medium. Details of the composition and preferable embodiments of the aggregation liquid that is used in this process are the same as those described above.

The application of the aggregation liquid can be carried out by known methods, such as a coating method, an ink jet method, or a dipping method. Examples of the coating method include known coating methods using, for example, a bar coater, an extrusion die coater, an air doctor coater, a blade coater, a rod coater, a knife coater, a squeeze coater, a reverse roll coater, or the like. Details of the ink jet method are the same as those described above with respect to the ink application process.

The aggregation liquid-application process may be provided before or after the ink application process described above. In the invention, an embodiment is preferable in which the ink application process is provided after the aggregation liquid application process. More specifically, an embodiment is preferable in which the aggregation liquid for aggregating color materials (preferably pigments) in ink is applied onto a recording medium beforehand before application of the ink, and then the ink is applied in such a manner as to become contact with the aggregation liquid applied onto the recording medium to form images. Thus, speeding up of the image formation can be achieved, and images with high density and high resolution are obtained, even in the case of high-speed printing.

An application amount of the aggregation liquid is not particularly limited insofar as ink can be aggregated and can be preferably adjusted so that the application amount of aggregating ingredients is 0.1 g/m² or more. In particular, the application amount of the aggregating ingredients is preferably from 0.1 to 2.0 g/m² and more preferably from 0.2 to 1.8 g/m². When the application amount of the aggregating ingredients is 0.1 g/m² or more, an aggregation reaction favorably proceeds. When the application amount is 2.0 g/m² or less, the glossiness does not become excessively high, and therefore such amount is preferable.

In the invention, it is preferable to provide the ink application process after the aggregation liquid application process, and further provide a drying-heating process for drying by heating the aggregation liquid on a recording medium in the period of time that is until the ink is applied after applying the aggregation liquid onto the recording medium. By drying by heating the aggregation liquid beforehand before the ink application process, ink coloring properties, such as prevention of ink bleeding, become favorable and visible images having favorable color density and hue can be recorded.

The heating-drying process can be carried out by a known heating unit, such as a heater, a blast unit utilizing blast, such as a drier, or a combination thereof. Examples of the heating method include a method of applying heat with a heater or the like from the side opposite to the surface of a recording medium to which the aggregation liquid is applied, a method of applying warm air or hot air to the surface of a recording medium to which the aggregation liquid is applied, and a heating method using an infrared heater or the like and the heating may be carried out by combining two or more of these methods.

Aspects of the invention are exemplified below. However, the present invention is not limited thereto.

<1> A maintenance liquid for ink jet recording, the maintenance liquid including: water and an organic solvent having an ether bond, a content of the organic solvent being in the range of from 15% by mass to 40% by mass with respect to a total mass of the maintenance liquid, and a concentration of peroxide in the maintenance liquid being 0.1 mmol/L or lower.
<2> The maintenance liquid for ink jet recording according to <1>, in which the organic solvent is a water-soluble organic solvent represented by the following Formula (1).

R¹—(OR²)ₓ—OR³ Formula (1)

wherein, in Formula 1, R² represents an ethylene group or a propylene group; each of R¹ and R³ independently represents a hydrogen atom or an alkyl group having 1 to 4 carbon atoms; and x represents an integer from 1 to 4.

<3> The maintenance liquid for ink jet recording according to <1> or <2>, in which a pH of maintenance liquid is from 6.0 to 8.5.
<4> The maintenance liquid for ink jet recording according to any one of <1> to <3> further including a basic compound having a pKa value of from 6.0 to 8.5.
<5> The maintenance liquid for ink jet recording according to <4> further including an acidic compound.
<6> A method of manufacturing a maintenance liquid for ink jet recording including water and an organic solvent having an ether bond, a content of the organic solvent being from 15% by mass to 40% by mass with respect to the maintenance liquid and a concentration of peroxide in the maintenance liquid being 0.1 mmol/L or lower, the method including:

a process for mixing water and the organic solvent having an ether bond; and

a process for purifying by distilling in advance the organic solvent having an ether bond that is used in the mixing.

<7> An ink set for ink jet recording including: the maintenance liquid for an ink jet recording according to any one of <1> to <5> and an aqueous ink composition having a pH of from 7.0 to 10.0.
<8> The ink set for ink jet recording according to <7>, in which the aqueous ink composition contains at least a pigment and polymer particles.
<9> The ink set for ink jet recording according to <7> or <8> further including an aggregation liquid containing an aggregating agent that aggregates components of the aqueous ink composition.
<10> An image forming method that uses the ink set for an ink jet recording according to any one of <7> to <9>, the method including: an ink application process for discharging the aqueous ink composition from an ink jet head to apply the ink onto a recording medium; and an ink removal process for removing a solid ink matter adhered to the ink jet head, with the maintenance liquid.
   <11> The image forming method according to <10> further including an aggregation liquid application process for applying an aggregation liquid onto the recording medium.

The invention can provide a maintenance liquid for ink jet recording in which a change in pH over time is suppressed and excellent maintenance performance is achieved over a long period of time, and a method of manufacturing the same. The invention can also provide an ink set for ink jet recording that maintains stable discharge performance over a long period of time, and an image forming method capable of forming high quality images.

### EXAMPLES

Hereinafter, the present invention will be described in more detail with reference to the following examples, although the present invention is not limited to these examples. “Parts” and “%” indicate quantities in terms of weight, unless otherwise specified.

The weight average molecular weight was herein measured by gel permeation chromatography (GPC). In the GPC, the measurement was carried out by the use of HLC-8020GPC (trade name, manufactured by Tosoh Corporation), three columns of TSK GEL, SUPER MULTIPORE HZ-H (trade name, manufactured by Tosoh Corporation; 4.6 mmID×15 cm), and THF (tetrahydrofuran) as an elute. The measurement was performed using an IR detector under the conditions of a sample concentration of 0.35% by mass, a flow rate of 0.35 ml/min., an injection amount of sample of 10 and a measurement temperature of 40° C. Calibration curves was prepared by eight samples of “REFERENCE SAMPLE TSK STANDARD, POLYSTYRENE” of “F-40”, “F-20”, “F-4”, “F-1”, “A-5000”, “A-2500”, “A-1000” and “n-propylbenzene” (all trade names, manufactured by Tosoh Corporation).

In addition, the acid values of polymers were obtained according to the method described in JIS Standard (JISK0070:1992).

Materials used in Examples were prepared as described below.

Preparation of Self-Dispersible Polymer Particles A-01

360.0 g of methyl ethyl ketone was placed in a 2 L three necked flask equipped with a stirrer, a thermometer, a reflux condenser tube, and a nitrogen gas introducing tube, and the temperature was raised to 75° C. Thereafter, while maintaining the temperature inside the flask at 75° C., a mixed solution containing 162.0 g of methyl methacrylate, 126.0 g of isobornylmethacrylate, 50.4 g of “PME-100” (trade name, manufactured by NOF CORPORATION, methoxypolyethyleneglycol methacrylate (n=2)), 21.6 g of methacrylic acid, 72 g of methyl ethyl ketone, and 1.44 g of V-601 (trade name, manufactured by Wako Pure Chemical Ind. Ltd.) was added dropwise at a constant rate so that the dropwise addition was completed in 2 hours. After completion of the dropping, a solution containing 0.72 g of V-601 (described above) and 36.0 g of methyl ethyl ketone was added, and stirred at 75° C. for 2 hours. Further, a solution containing 0.72 g of V-601 (described above) and 36.0 g of methyl ethyl ketone was added, and stirred at 75° C. for 2 hours. Thereafter, the temperature was raised to 85° C., and the stirring was continued for further 2 hours, thereby obtaining a resin solution of a methyl methacrylate/isobornylmethacrylate/PME-100/methacrylic acid (=45/35/14/6 [mass ratio]) copolymer.

The weight average molecular weight (Mw) of the obtained copolymer was 65,000 (calculated by gel permeation chromatography (GPC) in terms of polystyrene) and the acid value was 39 mgKOH/g. Further, the glass transition temperature (Tg) was 92° C.

Next, 668.3 g of the obtained resin solution was weighed, and 388.3 g of isopropanol and 145.7 ml of 1 mol/L NaOH aqueous solution were added. Then, the temperature inside the reactor was raised to 80° C. Next, 720.1 g of distilled water was added dropwise at a rate of 20 ml/min so that the copolymer resin is dispersed in water. Thereafter, the resultant was held under an atmospheric pressure at a temperature inside the reactor of 80° C. for 2 hours, and then maintained at 85° C. for 2 hours, and then further maintained at 90° C. for 2 hours. Then, the pressure inside the reactor was reduced, and isopropanol, methyl ethyl ketone, and distilled water were distilled off in a total amount of 913.7 g, to obtain water dispersion (emulsion) of the self-dispersible polymer particles A-01 having a solid content of 28.0% by mass.

Preparation of Water-Insoluble Polymer Dispersant

Methyl ethyl ketone (88 g) was placed in a 1000 ml three-necked flask equipped with a stirrer and a condenser tube, and heated to 72° C. under a nitrogen atmosphere. Separately, 0.85 g of dimethyl-2,2′-azobisisobutyrate, 60 g of benzyl methacrylate, 10 g of methacrylic acid, and 30 g of methyl methacrylate were dissolved in 50 g of methyl ethyl ketone to form a solution. The solution was added dropwise to the liquid in the flask over three hours. After the dropwise addition was completed, the reaction was further continued for one hour. Then, a solution obtained by dissolving 0.42 g of dimethyl 2,2′-azobisisobutyrate in 2 g of methyl ethyl ketone was added to the reaction solution, and the reaction solution was heated to 78° C. and heated at this temperature for 4 hours. The obtained reaction solution was reprecipitated twice with an excess quantity of hexane, and the precipitated resin was dried to obtain 96 g of the resin dispersant P-1 (water-insoluble copolymer). The dispersant P-1 includes benzylmethacrylate/methacrylic acid/methylmethacrylate copolymer (=60/10/30[mass ratio]).

The formulation of the obtained copolymer was identified with ¹H-NMR. The weight average molecular weight (Mw) was determined by a GPC method, and was found to be 44,600. Furthermore, the acid value of the polymer was found to be 65.2 mgKOH/g.

Preparation of Cyan Pigment Dispersion Liquid C

5.0 g of the above-obtained water-insoluble polymer dispersant P-1, 10.0 g of PIGMENT BLUE 15:3 (trade name, manufactured by Dainichiseika Color & Chemicals Mfg. Co., Ltd.), 40.0 g of methyl ethyl ketone, 8.0 g of 1 mol/L sodium hydroxide, 82.0 g of ion exchange water, and 300 g of 0.1 mm zirconea beads were fed to a vessel, and dispersed by READY MILL DISPERSOR (trade name, manufactured by IMEX) at the rate of 1000 rpm for 6 hours. The thus-obtained pigment dispersion liquid was concentrated under reduced pressure by an evaporator until methyl ethyl ketone was substantially distilled away. Specifically, the dispersion liquid was concentrated until the pigment density became about 12% by mass.

After that, the dispersion liquid was subjected to a centrifugal treatment at the rate of 8000 rpm for 30 minutes. As a result, coarse particles remaining as a precipitate were removed. Absorbance of the supernatant liquid was measured to determine the pigment density.

As described above, cyan pigment dispersion liquid C as a coloring material was prepared. Average particle size was 97 nm and aging particle size was 99 nm.

Preparation of Water-Soluble Organic Solvent

Details of water-soluble organic solvents used in the present Examples are described below.

GP 250: SANNIX GP-250 (trade name, manufactured by Sanyo Chemical Industries, Ltd., polyoxypropylated glycerin ether represented by the following formula, SP value=26.4)

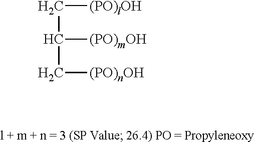

TPGmME: Tripropylene glycol monomethyl ether, manufactured by Wako Pure Chemical Industries, Ltd. (SP value=20.4)

DEGmBE: Diethylene glycol monobutyl ether, manufactured by Wako Pure Chemical Industries, Ltd. (SP value=21.5)

TEGmBE: Triethylene glycol monobutyl ether, manufactured by Wako Pure Chemical Industries, Ltd. (SP value=21.1)

DEGmEE: Diethylene glycol monoethyl ether, manufactured by Wako Pure Chemical Industries, Ltd. (SP value=22.4)

### Example 1

### 1. Preparation of Aqueous Ink Composition

Using the above-obtained cyan pigment dispersion liquid C and an aqueous dispersion of self-dispersing polymer particles A-01, ingredients incorporated therein were mixed so as to be the following percentage ink composition, thereby preparing an aqueous ink. The aqueous ink obtained above was packed in a plastic disposable syringe, and then filtrated through a polyvinylidene fluoride (PVDF) filter having pore sizes of 5 μm (MILLEX-SV, manufactured by Millipore Corporate, diameter of 25 mm). Thus, an aqueous ink composition was prepared. In addition, the pH (25° C.) of the aqueous ink composition (undiluted solution) was adjusted to 8.3.

Ink Composition

| | |
|---|---|
| Pigment blue 15:3 (Cyan pigment) | 2.5% |
| Water-insoluble polymer dispersant P-1 (solid content) | 1.25% |
| Self-dispersing polymer particles A-01 (solid content) | 8.0% |
| GP 250 | 8.0% |
| TPGmME (SP value = 20.4) | 8.0% |
| OLFINE E1010 (trade name, manufactured by Nissin | 1.0% |
| Chemical Industry Co., Ltd. surfactant) | |
| Ion exchange water | 71.25% |

Preparation of Aggregation Liquid

Components shown in the following formulation was mixed to prepare an aggregation liquid. The viscosity, surface tension, and pH (25±1° C.) of the aggregation liquid were measured to turn out to be 4.9 mPa·s, 24.3 mN/m, and 1.5, respectively.

In addition, measurement of the viscosity was conducted under conditions of 20° C. using VISCOMMETER TV-22 (trade name, manufactured by TOKI SANGYO CO., LTD.). Measurement of the surface tension was conducted under conditions of 25° C. using Automatic Surface Tensiometer CBVP-Z (trade name, manufactured by Kyowa Interscience Co., Ltd.).

Formulation of Aggregation Liquid

| | | |
|---|---|---|
| Dimethylamine/Epichlorohydrin copolymer | 5.0% | by mass |
| (Polymerization ratio 1:1 [mass ratio], | | |
| Weight average molecular weight 6000) | | |
| DEGmEE | 20.0% | by mass |
| ZONYL FSN-100 (trade name, manufactured | 1.0% | by mass |
| by DuPont) | | |
| Ion exchange water | 74% | by mass |

Preparation of Maintenance Liquid

Organic solvents shown in Table 1 and ion exchange water were mixed at a ratio (mass ratio) of Organic solvent: Ion exchange water=30:70, thereby preparing maintenance liquids 1 to 6. The pH (25° C.) of the maintenance liquid was adjusted to 8.0 with 1N potassium hydrate.

Purification by distillation of the organic solvents were performed using a Vigreux column by the following methods.

DEGmBE (boiling point of 230° C.) was slowly heated to 228° C. Distillates at temperatures lower than 228° C. were discarded as an initial distillate. Distillates at temperatures of from 228 to 232° C. were collected and distillates at temperatures of higher than 232° C. were discarded as a late distillate.

TEGmBE (boiling point of 255° C.) and DEGmEE (boiling point of 202° C.) were also purified by distillation according to the above method.

Measurement of Concentration of Peroxide

100 ml of a maintenance liquid was each placed in an Erlenmeyer flask, and then 1 ml of a saturated aqueous potassium iodide solution was added thereto. 0.1 ml-by-0.1 ml of 0.05N Na₂S₂O₃ aqueous solution was added dropwise, and the point where yellow disappeared was defined as the terminal point. From the amount (Xml) of the 0.05N Na₂S₂O₃ aqueous solution required for the disappearance of yellow, the concentration of peroxide of each of maintenance liquids was calculated based on the following equation. The results are shown in Table 1.

Concentration of peroxide (mmol/L)=0.5×X

TABLE 1

| | | | Concentration | |
|---|---|---|---|---|
| Maintenance | Organic | | of peroxide | |
| liquid No. | solvent | Distillation | (mmol/L) | Remarks |
| 1 | DEGmBE | Not done | 2.8 | Comparative |
| | | | | example |
| 2 | DEGmBE | Done | 0.0 | Present |
| | | | | invention |
| 3 | TEGmBE | Not done | 3.5 | Comparative |
| | | | | example |
| 4 | TEGmBE | Done | 0.0 | Present |
| | | | | invention |
| 5 | DEGmEE | Not done | 2.5 | Comparative |
| | | | | example |
| 6 | DEGmEE | Done | 0.0 | Present |
| | | | | invention |

Image Formation

The aqueous ink compositions, aggregation liquids, and various maintenance liquids obtained above were combined to make ink sets.

A recording medium TOKUBISH ART BOTH SIDE N (trade name, manufactured by Mitsubishi Paper Mill Limited, 84.9 g/m²) was fixed on a stage that can move to a predetermined straight direction at a speed of 500 mm/second. On to the recording medium, an aggregation liquid was coated with a wire coater so as to be a thickness of about 5 rim. Immediately after coating, the coated recording medium was dried at 50° C. for 2 seconds.

The inkjet composition was discharged so as to be an discharge amount of ink droplets of 3.5 μL and a coating amount of ink of 5 g/m² using a remodeled inkjet printer from GELJET GX 5000 printer (trade name, manufactured by Ricoh Company, Ltd.) as an inkjet recording apparatus. After the discharge, the maintenance liquid loaded in the inkjet printer was applied on to a nozzle surface of the head using a roller. Thereafter, the nozzle surface of the inkjet head was wiped using a wiper blade (hydrogenated NBR).

Evaluation

### Storage Stability of Maintenance Liquid

The maintenance liquid was each stored at 60° C. for 1 week. Then, the pH (25° C.) of the maintenance liquid after storage was measured, and then compared with pH 8.0 at the time of the above preparation. Based on the pH change calculated by the following equation, the storage stability was evaluated in accordance with the following evaluation criteria. The results are shown in Table 2.

ΔpH=(pH at the time of preparation)−(pH after storage)

Evaluation Criteria

A: ΔpH is 0.2 or less.

B: ΔpH is in the range of from more than 0.2 to 0.5.

C: ΔpH is in the range of from more than 0.5 to 2.0.

D: ΔpH is more than 2.0.

Maintenance Properties after Storage

In the above image forming method, discharge and the like were performed under the following (1) to (3) conditions, and the acceptability of the maintenance properties was judged based on the re-discharge properties thereafter. From the results of the acceptability, the maintenance properties were evaluated in accordance with the following evaluation criteria. The results are shown in Table 2.

Conditions of Discharge or the Like and Criteria for Acceptability

(1) The maintenance liquid was applied to a nozzle surface of a head immediately after completion of 60 minute-continuous-discharge, and then blade wiping was performed one time. Thereafter, the case where the ink discharge rate is 90% or more is acceptable.
(2) After 1 minute-continuous-discharge, discharge was suspended for 30 minutes. After the suspension, the maintenance liquid was applied to a nozzle surface of a head, and then blade wiping was performed one time. Thereafter, the case where the ink discharge rate is 90% or more is acceptable.
(3) Immediately after completion of 10 minute-continuous-discharge, the maintenance liquid was applied to a nozzle surface, and then blade wiping was performed one time. Then, the case where image unevenness in the images formed thereafter is not visually observed is acceptable.

### Method of Measuring Ink Discharge Rate

After confirming that all nozzles discharge ink at the time of starting an experiment, the number of the nozzles discharging ink after wiping was counted. Then, the discharge rate was calculated from the following equation.

Discharge rate (%)=(Number of nozzles discharging ink after wiping)/(Total number of nozzles)×100

### Evaluation Criteria

A: Three items are acceptable.
B: Only two items are acceptable.
C: Only one item is acceptable.

TABLE 2

| | | Concentra- | | | |
|---|---|---|---|---|---|
| Mainte- | | tion of | | Mainte- | |
| nance | Organic | peroxide | Storage | nance | |
| liquid No. | solvent | (mmol/L) | stability | properties | Remarks |
| 1 | DEGmBE | 2.8 | D | D | Comparative |
| | | | | | example |
| 2 | DEGmBE | 0.0 | A | A | Present |
| | | | | | invention |
| 3 | TEGmBE | 3.5 | D | D | Comparative |
| | | | | | example |
| 4 | TEGmBE | 0.0 | B | B | Present |
| | | | | | invention |
| 5 | DEGmEE | 2.5 | D | D | Comparative |
| | | | | | example |
| 6 | DEGmEE | 0.0 | B | B | Present |
| | | | | | invention |

As shown in Table 2, in the maintenance liquids for an ink jet recording of the invention, change in pH over time was small and the storage stability was high. In contrast, in the maintenance liquids for an ink jet recording of the Comparative Examples, the pH considerably decreased, so that the liquids became acidic. From the results, it is seen that, in the maintenance liquids for an ink jet recording of the invention, change in pH over time is suppressed.

Moreover, as shown in Table 2, in all ink sets using the maintenance liquids for ink jet recording of the invention, the maintenance properties were excellent, a discharge head portion was favorably cleaned, and the occurrence of clogging failure of the head was suppressed. From these results, it is seen that the maintenance liquids for an ink jet recording of the invention have excellent maintenance properties over a long period of time. Further, it is seen that the ink sets for an ink jet recording of the invention maintain stable discharge properties over a long period of time.

### Example 2

To the maintenance liquid 2 produced in Example 1, 0.1 M of the basic compound shown in Table 3 was added, and then the pH (25° C.) was adjusted to 7.0 with the acidic compound shown in Table 3, thereby producing maintenance liquids 7 to 11. The maintenance liquids 2 and 7 to 11 were evaluated in terms of storage stability and maintenance properties after storage in the same manner as in Example 1. In order to make the evaluation results conspicuous, evaluation was conducted under forced storage conditions 60° C. for 4 weeks.

TABLE 3

| | Concentration | | | | | |
|---|---|---|---|---|---|---|
| Maintenance | of peroxide | Basic compound | Acidic | Storage | Maintenance | |
| liquid | (mmol/L) | (pKa) | compound | stability | properties | Remarks |
| 2 | 0.0 | — | — | B | B | Present |
| | | | | | | invention |
| 7 | 0.0 | Imidazole | Hydrochloric | A | B | Present |
| | | (7.0) | acid | | | invention |
| 8 | 0.0 | Imidazole | Nitric acid | A | A | Present |
| | | (7.0) | | | | invention |
| 9 | 0.0 | Imidazole | Sulfuric acid | A | A | Present |
| | | (7.0) | | | | invention |
| 10 | 0.0 | Trishydroxymethyl- | Nitric acid | A | B | Present |
| | | aminomethane | | | | invention |
| | | (8.3) | | | | |
| 11 | 0.0 | Triethanolamine | Nitric acid | A | B | Present |
| | | (7.8) | | | | invention |

As shown in Table 3, it is seen that, in the maintenance liquids of the invention containing a basic compound having a pKa value of from 6.0 to 8.5 and an acidic compound, storage stability is further improved and excellent maintenance properties are achieved over a longer period of time.

All publications, patent applications, and technical standards mentioned in this specification were herein incorporated by reference to the same extent as if each individual publication, patent application, or technical standard was specifically and individually indicated to be incorporated by reference.

What is claimed is:

1. A maintenance liquid for ink jet recording, the maintenance liquid comprising: water and an organic solvent having an ether bond, a content of the organic solvent being from 15% by mass to 40% by mass with respect to a total mass of the maintenance liquid and a concentration of peroxide in the maintenance liquid being 0.1 mmol/L or lower.

2. The maintenance liquid for ink jet recording according to claim 1, wherein the organic solvent is a water-soluble organic solvent represented by the following Formula (1):
R¹—(OR²)ₓ—OR³ Formula (1)
wherein, in Formula 1, R² represents an ethylene group or a propylene group; each of R¹ and R³ independently represents a hydrogen atom or an alkyl group having 1 to 4 carbon atoms; and x represents an integer from 1 to 4.

3. The maintenance liquid for ink jet recording according to claim 1, wherein a pH of the maintenance liquid is from 6.0 to 8.5.

4. The maintenance liquid for ink jet recording according to claim 1, further comprising a basic compound having a pKa value of from 6.0 to 8.5.

5. The maintenance liquid for ink jet recording according to claim 4, further comprising an acidic compound.

6. A method of manufacturing a maintenance liquid for ink jet recording, the maintenance liquid comprising water and an organic solvent having an ether bond, a content of the organic solvent being from 15% by mass to 40% by mass with respect to a total mass of the maintenance liquid and a concentration of peroxide in the maintenance liquid being 0.1 mmol/L or lower, the method comprising:
mixing water and the organic solvent having an ether bond; and
purifying by distilling in advance the organic solvent having an ether bond that is used in the mixing.

7. An ink set for ink jet recording including: the maintenance liquid for an ink jet recording according to claim 1 and an aqueous ink composition having a pH of from 7.0 to 10.0.

8. The ink set for ink jet recording according to claim 7, wherein the aqueous ink composition comprises at least a pigment and polymer particles.

9. The ink set for ink jet recording according to claim 7, further comprising an aggregation liquid comprising an aggregating agent that aggregates components of the aqueous ink composition.

10. An image forming method that uses the ink set for ink jet recording according to claim 7, the method comprising:
discharging the aqueous ink composition from an ink jet head to apply the ink onto a recording medium; and
removing solid ink matter attached to the ink jet head using the maintenance liquid.

11. The image forming method according to claim 10, further comprising applying an aggregation liquid onto the recording medium.
